(19) United States
(12) Patent Application Publication
(10) Pub. No.: US 2006/0187560 A1
(43) Pub. Date: Aug. 24, 2006

(54) Lens barrel assembly and lens assembly including the same

(75) Inventors: Tsung-Ling Chou, Tan-Tzu Hsiang (TW); Min-Hung Wang, Tan-Tzu Hsiang (TW)

Correspondence Address: FROMMER LAWRENCE & HAUG, 745 FIFTH AVENUE- 10TH FL., NEW YORK, NY, 10151, US

(73) Assignee: ASIA OPTICAL CO., INC.

(21) Appl. No.: 11/311,071

(22) Filed: Dec. 19, 2005

(30) Foreign Application Priority Data
Feb. 18, 2005 (TW) 094104816

(51) Int. Cl. G02B 7/02

(52) U.S. Cl. 359/819

(57) ABSTRACT

A lens barrel assembly includes a first lens barrel and a second lens barrel. The first lens barrel includes a peripheral wall having a first end portion, a second end portion opposite to the first end portion, and a plurality of cam slots extending between the first end portion and the second end portion. Each of the cam slots defines two opposite guiding walls. The second lens barrel is disposed slidably in the first lens barrel, and includes an annular body, and a plurality of cam followers mounted on the annular body and extending through the cam slots, respectively. Each of the cam followers has a shank portion, a head portion, and a rolling member disposed around the shank portion and stopped by the head portion. The rolling member has a spherical outer surface for contacting the guiding walls of one of the cam slots.

### CROSS-REFERENCE TO RELATED APPLICATION

This application claims priority of Taiwanese Application No. 094104816, filed on Feb. 18, 2005.

### BACKGROUND OF THE INVENTION

1. Field of the Invention

The invention relates to a lens barrel assembly, more particularly to a lens barrel assembly in which lens barrels are movable relative to each other with reduced friction and improved accuracy. The invention also relates to a lens assembly including the lens barrel assembly.

2. Description of the Related Art

Referring to FIGS. 1 and 2, a conventional lens assembly includes an outer barrel 1 and an inner barrel 2 disposed slidably in the outer barrel 1. The outer barrel 1 has a peripheral wall 102 defining a receiving space 101. The peripheral wall 102 includes a first end portion 103, a second end portion 104 opposite to the first end portion, and a plurality of cam slots 105 extending spirally in the peripheral wall 102 from the first end portion 103 to the second end portion 104. Each of the cam slots 105 includes two opposite guiding walls 106 and two opposite convergent walls 107, each of which interconnects the guiding walls 106. The inner lens barrel 2 is disposed slidably in the receiving space 101, and includes an annular body 201, a plurality of cam followers 202 mounted on the annular body 201, a plurality of cylindrical rolling members 203 disposed around the cam followers 202, respectively, and a plurality of lenses 204 disposed in the annular body 201. Referring to FIG. 3, since each of the rolling members 203 is formed as a cylindrical shape, each of the rolling members 203 contacts the guiding walls 106 of a corresponding one of the cam slots 105 in a linear relationship. Therefore, there is a relatively large friction between the rolling members 203 and the guiding walls 106 when the cylindrical rolling member 203 deviates from a radial position relative to the annular body 201 during operation of the conventional lens assembly.

### SUMMARY OF THE INVENTION

Therefore, one object of the present invention is to provide a lens barrel assembly in which lens barrels are movable relative to each other with reduced friction and improved accuracy.

Another object of the present invention is to provide a lens assembly in which the lens barrels are movable relative to each other with reduced friction and improved accuracy.

In one aspect of this invention, a lens barrel assembly includes a first lens barrel and a second lens barrel. The first lens barrel includes a peripheral wall having a first end portion, a second end portion opposite to the first end portion, and a plurality of cam slots extending between the first end portion and the second end portion. Each of the cam slots defines two opposite guiding walls. The second lens barrel is disposed slidably in the first lens barrel, and includes an annular body, and a plurality of cam followers mounted on the annular body and extending through the cam slots, respectively. Each of the cam followers has a shank portion, a head portion, and a rolling member disposed around the shank portion and stopped by the head portion. The rolling member has a spherical outer surface for contacting the guiding walls of one of the cam slots.

In another aspect of this invention, a lens assembly includes a first lens barrel, a second lens barrel, and lens member. The first lens barrel includes a peripheral wall defining a receiving space and having a first end portion, a second end portion opposite to the first end portion, and a plurality of cam slots extending between the first end portion and the second end portion. Each of the cam slots is communicated with the receiving space, and defines two opposite guiding walls. The second lens barrel is disposed slidably in the receiving space of the first lens barrel, and includes an annular body, and a plurality of cam followers mounted on the annular body. Each of the cam followers has a shank portion, a head portion, and a rolling member disposed around the shank portion and stopped by the head portion. The shank portion extends radially and outwardly from the annular body and through a corresponding one of the cam slots. The rolling member has a spherical outer surface for contacting the guiding walls of one of the cam slots. The lens member includes a lens mounted in the annular body of the second lens barrel.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional lens assembly;

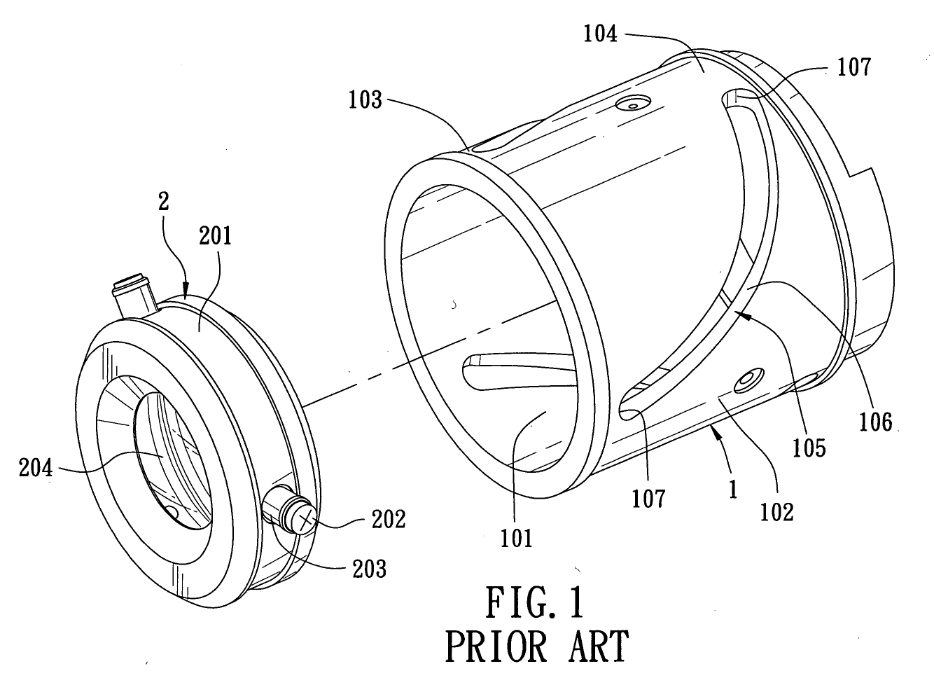

FIG. 2 is a sectional view of the conventional lens assembly;

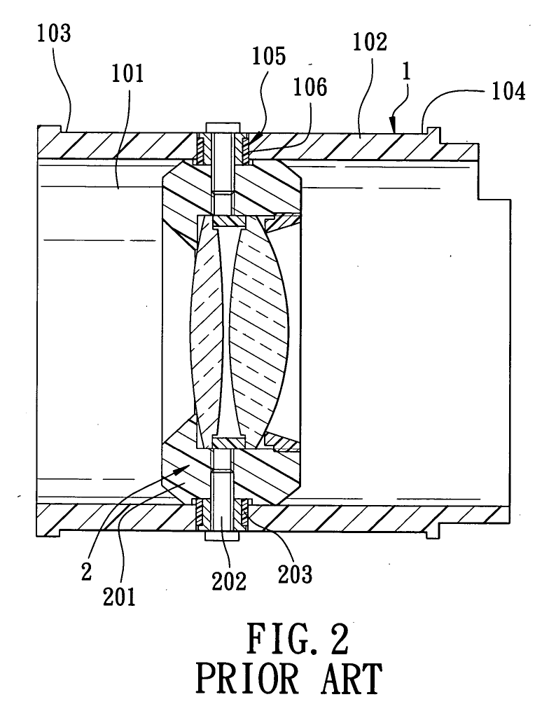

FIG. 3 is an enlarged fragmentary schematic sectional view of the conventional lens assembly;

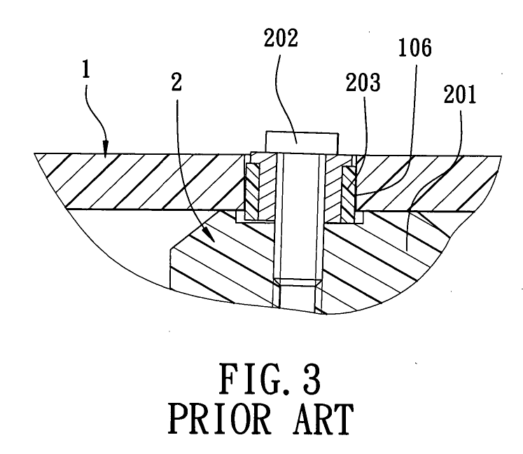

FIG. 4 is an exploded perspective view of the preferred embodiment of a lens assembly according to this invention;

FIG. 5 is a sectional view of the preferred embodiment; and

FIG. 6 is an enlarged fragmentary schematic sectional view of the preferred embodiment.

### DETAILED DESCRIPTION OF THE PREFERRED EMBODIMENT

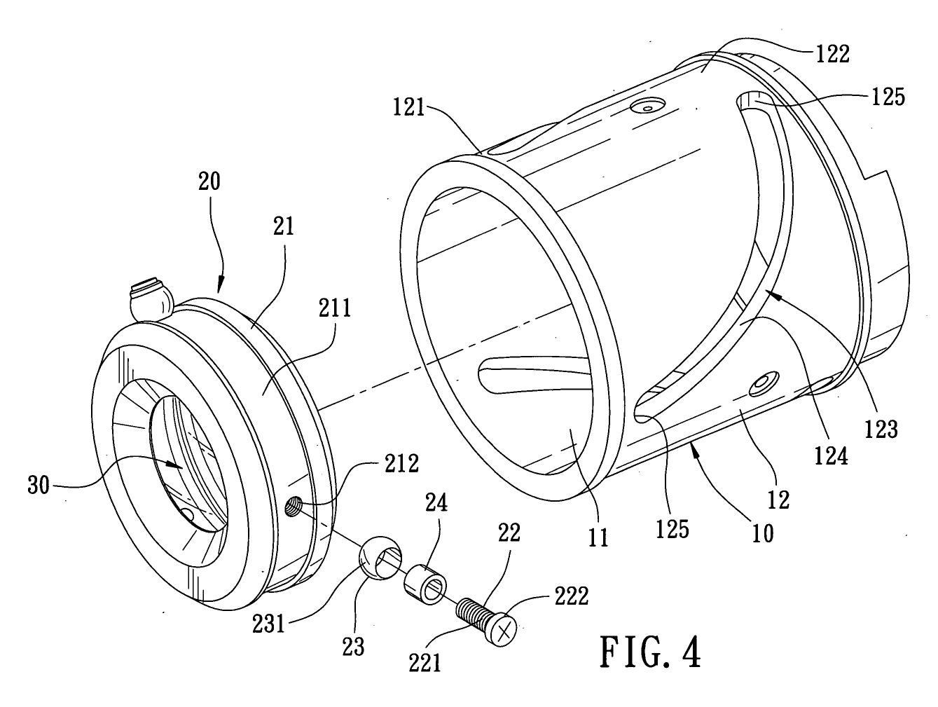

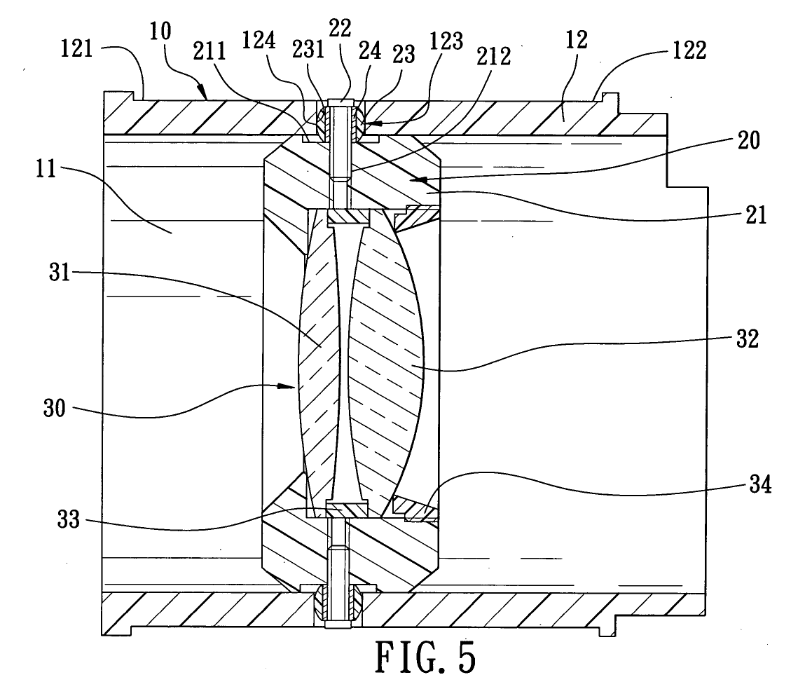

Referring to FIGS. 4 and 5, the preferred embodiment of a lens assembly according to this invention includes a first lens barrel 10, a second lens barrel 20, and a lens member 30.

The first lens barrel 10 is configured in a cylindrical shape, and includes a peripheral wall 12 defining a receiving space 11 and having a first end portion 121, a second end portion 122 opposite to the first end portion 121, and a plurality of cam slots 123 extending spirally in the peripheral wall 12 between the first end portion 121 and the second end portion 122. Each of the cam slots 123 is communicated with the receiving space 11, and defines two opposite guiding walls 124 and two opposite convergent walls 125, each of which interconnects the guiding walls 124.

The second lens barrel 20 is disposed slidably in the receiving space 11 of the first lens barrel 10, and includes an annular body 21, and a plurality of cam followers 22 mounted on the annular body 21. Each of the cam followers 22 has a shank portion 221, a head portion 222, a rolling member 23 disposed around the shank portion 221 and stopped by the head portion 222, and a bushing 24 disposed between the shank portion 221 and the rolling member 23. In the preferred embodiment, the rolling member 23 is made of plastic material, and the bushing 24 is made of copper. The annular body 21 has an outer annular surface 211 and a plurality of threaded holes 212 provided on the annular body 21 and spaced apart from each other. The shank portion 221 is coupled threadedly to the annular body 21 at a corresponding one of the threaded holes 212, and extends radially and outwardly from the annular body 21 and through a corresponding one of the cam slots 123. The rolling member 23 has a spherical outer surface 231 for contacting the guiding walls 124 of one of the cam slots 123. The lens member 30 includes two lenses 31,32 mounted in the annular body 21 of the second lens barrel 20, an annular spacer 33 disposed between the lenses 31,32, and a press ring 34 disposed proximate to the lens 32.

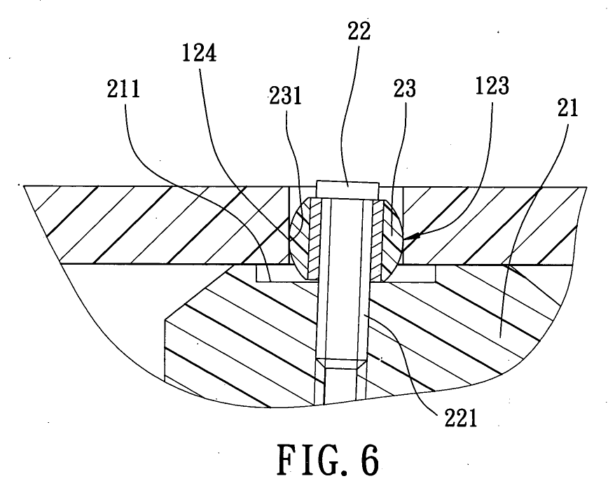

Referring to FIG. 6, since each of the rolling members 23 is formed with the spherical outer surface 231, each of the rolling members 23 contacts the guiding walls 124 of the corresponding one of the cam slots 123 in a point relationship. Therefore, there is a relatively small friction between the rolling members 23 and the guiding walls 124 during the operation of the lens assembly of this invention as compared to the aforesaid prior art. Accordingly, the accuracy of the lens assembly of this invention is improved. Furthermore, even when the shank portion 221 deviates from a radial position relative to the annular body 21, the rolling member 23 maintains the point contact relationship with the guiding walls 124 of the corresponding one of the cam slots 123.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A lens barrel assembly, comprising:
a first lens barrel including a peripheral wall having a first end portion, a second end portion opposite to said first end portion, and a plurality of cam slots extending between said first end portion and said second end portion, each of said cam slots defining two opposite guiding walls; and
a second lens barrel disposed slidably in said first lens barrel, and including an annular body, and a plurality of cam followers mounted on said annular body and extending through said cam slots, respectively, each of said cam followers having a shank portion, a head portion, and a rolling member disposed around said shank portion and stopped by said head portion, said rolling member having a spherical outer surface for contacting said guiding walls of one of said cam slots.

2. The lens barrel assembly as claimed in claim 1, wherein each of said cam slots extends spirally in said peripheral wall from said first end portion to said second end portion of said first lens barrel.

3. The lens barrel assembly as claimed in claim 1, wherein each of said cam followers further includes a bushing disposed between said shank portion and said rolling member.

4. A lens assembly, comprising:
a first lens barrel including a peripheral wall defining a receiving space and having a first end portion, a second end portion opposite to said first end portion, and a plurality of cam slots extending between said first end portion and said second end portion, each of said cam slots being communicated with said receiving space, and defining two opposite guiding walls;
a second lens barrel disposed slidably in said receiving space of said first lens barrel, and including an annular body, and a plurality of cam followers mounted on said annular body, each of said cam followers having a shank portion, a head portion, and a rolling member disposed around said shank portion and stopped by said head portion, said shank portion extending radially and outwardly from said annular body and through a corresponding one of said cam slots, said rolling member having a spherical outer surface for contacting said guiding walls of one of said cam slots; and
a lens member including a lens mounted in said annular body of said second lens barrel.

5. The lens assembly as claimed in claim 4, wherein each of said cam slots extends spirally in said peripheral wall from said first end portion to said second end portion of said first lens barrel.

6. The lens barrel assembly as claimed in claim 4, wherein each of said cam followers further includes a bushing disposed between said shank portion and said rolling member.
